(19) United States
(12) Patent Application Publication
(10) Pub. No.: US 2017/0149699 A1
(43) Pub. Date: May 25, 2017

(54) Systems and Methods for Delivering Notifications Associated with Pets, Children or Individuals with Communication Limitations

(71) Applicant: Petsnikker LLC, Gunter, TX (US)

(72) Inventor: John F. Hinson, JR., Coppell, TX (US)

(21) Appl. No.: 15/355,378

(22) Filed: Nov. 18, 2016

Related U.S. Application Data
(60) Provisional application No. 62/257,638, filed on Nov. 19, 2015.

(51) Int. Cl. H04L 12/58

(52) U.S. Cl. CPC H04L 51/02; H04L 51/10

(57) ABSTRACT

A disclosed method includes providing a plurality of event triggers; providing at least one photograph or other electronic media associated with a pet, child or person identifier; providing at least one subscriber address associated with the pet, child or person identifier; and providing a plurality of greeting messages, wherein each of the plurality of greeting messages corresponds to at least one of the plurality of triggering events. The method also includes determining a current status and comparing it to the triggering events. If the current status corresponds to one of the plurality of triggering events, the method includes selecting one of the plurality of greeting messages corresponding to the one of the plurality of triggering events and selecting one of the at least one photograph associated with the identifier; and sending the selected greeting message and photograph and/or other digital media to a subscriber address associated with the identifier.

### CROSS-REFERENCE TO RELATED APPLICATIONS

Pursuant to 35 U.S.C. §119(e), this application claims the benefit of, and hereby incorporates by reference for all purposes, U.S. Provisional Patent Application Ser. No. 62/257,638, entitled “SYSTEMS AND METHODS FOR DELIVERING NOTIFICATIONS ASSOCIATED WITH PETS, CHILDREN OR INDIVIDUALS WITH COMMUNICATION LIMITATIONS,” filed Nov. 19, 2015.

### BACKGROUND OF THE DISCLOSURE

Pet owners often desire to communicate with their pets. As such, pet owners spend time training and coaching their pets to respond to commands and other gestures. For example, a dog owner may train a dog to respond to short commands, such as, “sit,” “stay,” and “come.” If the dog responds to such commands, the pet owner and the dog feel a bond resulting from the successful communication. The bond formed between a pet owner and a pet can be very strong. In many instances, pet owners form deep relationships with their pets and consider their pets to be part of their family. In these types of relationships, pets provide emotional support and companionship to their owners and others who interact with the pet.

While currently available means for communicating with pets provide some ability for pets to communicate with their owners, the currently available communication options are very limited. For example, a pet's ability to respond to verbal commands is typically limited to physical movement or, in some cases, noises that the pet can make on its own. Many pet owners feel the need for more complete communication with their pets, or at least the appearance of such communication.

In addition, parents, friends and other people may feel the desire to communicate more effectively with children and other people who may be unable to communicate due to communication limitations. For example, a small child may be unable to express verbal words or sentences because the child has not yet learned to speak. Parents and other people often desire the ability to communicate more effectively with children and people with communication limitations.

### SUMMARY

This summary is provided to introduce a selection of embodiments and aspects of this disclosure in a simplified form that are further described below in the Detailed Description. Embodiments are directed to methods and systems for enabling enhanced communication (or at least the appearance of enhanced communication) between pets, children, people with speech or communication limitations, and/or other people. In some embodiments, for example, the system and method send customized electronic messages, emails, animations or other digital content to pet owners or other people. In some embodiments, a text message or email is customized to appear as if the pet, child or person with communication limitations had sent the text message or email. In other embodiments, a message and another electronic media, such as a picture, animation, movie, sound, or other media, are customized to appear as if the pet, child or person with communication limitations had sent the message and electronic media. In some embodiments, for example, the electronic media may include an animation in which it appears as if the pet is speaking an audible message to the pet owner. In some embodiments, it appears as if the pet has sent the electronic media. Thus, the communication between the pet owner and the pet is enhanced as the owner feels as if the pet is able to communicate via the text message, email or other electronic media. In some embodiments, the message and/or electronic media are automatically sent in response to a triggering event, such as a triggering date, triggering location, or other event. In some embodiments, the available triggering dates include holidays and user-selected dates, such as birthdays, anniversaries, or other personal dates.

In a first aspect, there is provided a method, implemented in computer-executable program(s) or computer-executable instruction(s) in computer system(s) or device(s), including steps of: receiving, at a processor, a plurality of event dates from a first server; receiving, at the processor, at least one photograph associated with an identifier, the at least one photograph received from a second server; receiving, at the processor, at least one subscriber address associated with the identifier; receiving, at the processor, a plurality of greeting messages from a third server, wherein each of the plurality of greeting messages corresponds to at least one of the plurality of event dates; determining, via the processor, a current calendar date; comparing, via the processor, the current calendar date to the plurality of event dates; if the current calendar date corresponds to one of the plurality of event dates, selecting, via the processor, one of the plurality of greeting messages corresponding to the one of the plurality of event dates and selecting, via the processor, one of the at least one photograph associated with the identifier; and transmitting, via the processor, the selected greeting message and the selected photograph to the at least one subscriber address associated with the identifier.

In some embodiments, the method further includes combining, via the processor, the selected greeting message and the selected photograph into a combined image.

In another embodiment, combining the selected greeting message and the selected pet photograph into a combined image further includes positioning the selected greeting message in an overlaid position on at least part of the selected pet photograph.

In another embodiment, at least some of the event dates correspond to holidays.

In yet another embodiment, at least some of the event dates are user-selected dates.

In still another embodiment, the content of each of the plurality of greeting messages relates to a corresponding event date of the plurality of event dates.

In additional embodiments, the subscriber address is an email address.

In a second aspect, there is provided a method of delivering a message to a computing device on behalf of a pet, the method including: storing, at a first server, a plurality of pet images corresponding to a first identifier; receiving a plurality of subscriber addresses corresponding to the first identifier; storing, at a second server, a plurality of greeting messages, wherein each of the plurality of greeting messages corresponds to a triggering event; comparing, via a processor, a current status to the triggering event; and if the current status corresponds to the triggering event, sending, via the processor, at least one of the plurality of pet images and at least one of the plurality of greeting messages corresponding to the triggering event to the subscribers addresses corresponding to the first pet identifier

In some embodiments, the method also includes storing, at the first server, a second plurality of images corresponding to a second pet identifier and receiving a second plurality of subscribers addresses corresponding to the second pet identifier.

In other embodiments, if the current status corresponds to one of the plurality of triggering events, sending, via the processor, at least one of the second plurality of pet images and at least one of the plurality of greeting messages corresponding to the triggering event to the second plurality of subscriber addresses.

In another embodiment, the subscriber addresses are email addresses.

In yet another embodiment, the subscriber addresses are phone numbers.

In some embodiments, sending at least one of the plurality of pet images and at least one of the plurality of greeting messages corresponding to the triggering event to the subscriber addresses corresponding to the first pet identifier further includes combining the at least one of the plurality of pet images and at least one of the plurality of greeting messages into a combined image.

In some embodiments, if the current status corresponds to one of the plurality of triggering events, randomly selecting, via the processor, one of the plurality of greeting messages corresponding to the one of the plurality of triggering events.

In a third aspect, there is provided a system for delivering a message to an electronic device on behalf of a pet, the system including: a first server configured to store a plurality of pet images each corresponding to one of a plurality of pet identifiers; a second server configured to store a plurality of pet greetings each corresponding to one of a plurality of triggering events; a third server configured to store a plurality of greeting messages each corresponding to one or more of the plurality of triggering events; and a processor configured to compare a current status to the plurality of event triggers and, if the current status matches one of the plurality of event triggers, to transmit over a network, to a plurality of subscriber addresses associated with a first pet identifier, at least one of the plurality of pet images corresponding to the first pet identifier of the plurality of pet identifiers and one of the plurality of pet greetings corresponding to one of the plurality of triggering events corresponding to the current status.

In other embodiments, the processor is configured to send an electronic message containing the at least one of the plurality of pet images corresponding to the first pet identifier and the one of the plurality of pet greetings corresponding to one of the plurality of triggering events that corresponds to the current status.

In another embodiment, the processor is configured to send an email message containing the at least one of the plurality of pet images corresponding to the first pet identifier of the plurality of pet identifiers and the one of the plurality of pet greetings corresponding to one of the plurality of triggering events that corresponds to the current status.

In some embodiments, the triggering events are event dates.

In some embodiments, the network is a cellular or other wireless network.

### DESCRIPTION OF THE FIGURES

The accompanying drawings facilitate an understanding of the various embodiments.

FIG. 1A is a block diagram of an exemplary operating environment for use in implementing an embodiment or a portion of an embodiment of the present disclosure.

FIG. 1B is a block diagram of a network environment for use in implementing an embodiment of the present disclosure.

FIG. 2 is a block diagram illustrating a method of adding a pet identifier and images or other electronic media to be sent to subscribers at specified triggering events.

FIGS. 3A, 3B, and 3C are example embodiments of a user interface for adding a pet identifier and pet-related data in accordance with this disclosure.

FIG. 4 is an example embodiment of a user interface for viewing pictures, videos and other digital content associated with a pet identifier in accordance with this disclosure.

FIG. 5 is an example embodiment of a user interface for sharing photographs, videos, other digital media, and greeting messages corresponding to a pet identifier in accordance with this disclosure.

FIG. 6 is an example embodiment of a user interface for sharing photographs, videos, other digital media and greeting messages to subscribers with a corresponding account in accordance with this disclosure.

FIG. 7 is an example embodiment of a user interface for sharing photographs, videos, other digital media and greeting messages with third parties via email in accordance with this disclosure.

FIG. 8 is an example embodiment of a user interface for modifying and/or adding an event date, which may be a trigger event, in accordance with this disclosure.

FIG. 9 is an example embodiment of a user interface for managing multiple pet identifiers in accordance with this disclosure.

FIG. 10 is an example embodiment of a user interface for viewing a plurality of greeting messages and digital media associated with a plurality of pet identifiers in accordance with this disclosure.

FIG. 11 is a block diagram illustrating an embodiment of a method of delivering greeting messages to subscribers on event dates or other triggering events.

FIG. 12 is an example embodiment of a user interface for viewing a combined image including a pet photograph, video, animation, or other digital media and a greeting message in accordance with this disclosure.

### DETAILED DESCRIPTION

Pet owners often desire to communicate more effectively and completely with their pets. In addition, people often desire to communicate more effectively with children who cannot yet fully communicate or other people with communication limitations. Embodiments described herein generally relate to a new system and method for promoting the appearance of pets, children or people with communication limitations communicating with pet owners, family, friends and other people. While many of the embodiments illustrated herein pertain to pets and pet owners, the systems and methods are equally applicable to children and other people with communication limitations.

In one embodiment, a user identifies one or more pets or, in other embodiments, one or more children or people, to add to a user's account. In some embodiments, the pet, child or person may be living or deceased. Each pet, child or person is associated with an identifier such as a pet identifier, child identifier or person identifier, respectively. The user may then upload at least one photograph, video, animation, sound or other digital file relating to each identifier to a digital content server. The user can then identify a desired method of inviting third parties to receive notifications associated with the pet identifier, such as, but not limited to, via email, text message or push notification. In some embodiments, a message is sent via email, text message or push notification to the third parties to invite them to download a mobile app and accept notifications, messages and/or other digital content associated with a particular pet, child or person identifier. In some embodiments, the notifications, messages and/or other digital content are sent to a user and any third parties that have accepted an invitation. The notifications, messages and other digital content are sent in response to a current status, such as a current location, time, date or other feature of the user, the pet, the user's computing device, the subscriber's computing device, or other contemporaneous attribute, corresponding to a triggering event, such as a triggering date, triggering location, or other event. For example, in some embodiments the notifications, messages and/or other digital content are sent on specified dates or when a user's mobile device enters a specified GPS location or range of locations. In some embodiments, the system and method sends a customized greeting and a photograph, video or other digital file to the user and all other third parties that have accepted an invitation (“subscribers”) when a current status corresponds to a triggering event. In some embodiments, the system and method sends a greeting and a photograph, video or other digital file to only the user depending on the current status and the triggering event, such as a personal birthday, anniversary, or other personal date. In some embodiments, the system and method sends a greeting and a photograph, video or other digital file to the user and only select subscribers that meet certain criteria depending on the triggering event, such as membership in a family group, donation to a particular pet-related charity, or other characteristic. When such greetings, photographs, videos, and/or other digital files are sent, it appears to the user and/or third parties as if the pet, child, or person with communication limitations has send the email, text message, push notification or other digital media to the user and the third parties. In some embodiments, the user and/or the subscribers can customize the trigger events to include personalized triggering events, such as birthdays, anniversaries, home locations, favorite stores, family and friends' homes, and other personal triggers, and can also customize the message according to the corresponding pet or other preferences of the user. In some embodiments, for example, an event date, such as a user's birthday, triggers delivery of a customized message. In some embodiments, the customized message pertains to the triggering event. Thus, for example, the message may include the phrase “Happy Birthday, Dad,” and a video, picture, sound, or other digital media showing the pet, child or person.

In some embodiments, the user and/or third parties submit pictures, videos, or other digital content pertaining to a pet, child or person identifier to a digital media server. In response to a current status corresponding to a triggering event, the system sends one or more of the stored pictures, videos, or other digital contents to the user and the subscribers. Thus, in some embodiments, the user and third parties receive digital media of their pet, child or other person in response to a triggering event. Thus, for example, when a current status, such as a current calendar date, corresponds to the triggering event, such as the user's birthday, a greetings server may randomly select a greeting message corresponding to the event date (such as, for example, “Happy Birthday!”) and a randomly selected digital media file, such as a photograph, video or other digital content that was submitted by the user or a third party. Accordingly, it appears as if the pet has sent a message and digital media to the user on the user's birthday.

Triggering events are not limited to dates but may include other triggers, such as location-based triggers, time duration-based triggers or any other triggering event. The current status is also not limited to the current date but may include other status events, such as a current GPS location, a current time, a time since the last message or other current characteristic of the date, the time, the user, the user's computing device, the user's pet, or other characteristic associated with the pet, the user or a subscriber. In some embodiments, for example, the triggering event is based on the GPS location of the user's cell phone, the passage of a specified period of time between messages, or some other trigger. Thus, for example, in some embodiments the user receives a message and/or digital media from his/her pet when the user is near a pet supply store (e.g., “Don't forget to fill up on dog food.”) or near a pet park (e.g., “Lets run around the park today!”).

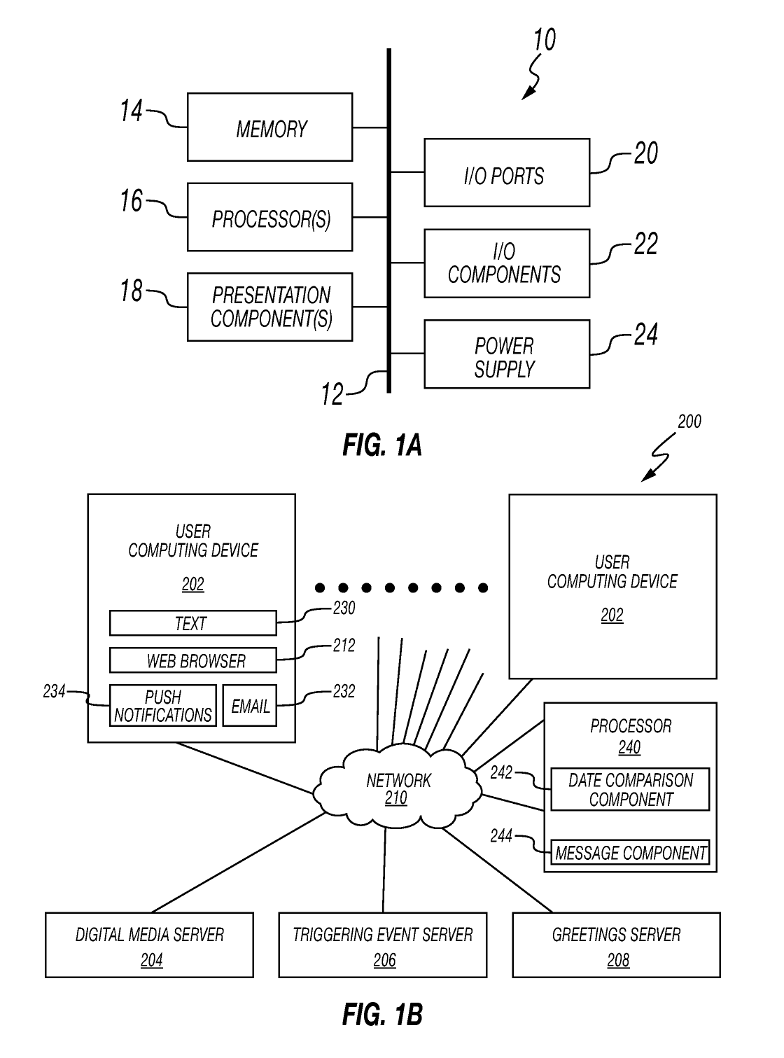

Having described a general overview of the embodiments described herein, an exemplary operating environment is described below. Referring initially to FIG. 1A in particular, an exemplary operating environment for implementing the present invention is shown and designated generally as computing device 10. The operating environment may include hardware, software and other elements that may be fully or partially located in a cloud of servers. The computing device 10 is but one example of a suitable computing environment and is not intended to suggest any limitations as to the scope of use or functionality of the disclosure. Neither should computing device 10 be interpreted as necessarily having any dependency or requirement relating to any one or combination of components illustrated. The disclosure may be described in the general context of a computer code or machine-usable instructions, including computer-executable instructions such as program modules, being executed by a computer or other machine, such as a PDA, smartphone or other handheld device. Generally, program modules that include routines, programs, objects, components, data structures, and the like, refer to code that perform particular tasks or implement particular abstract data types. The modules described herein may represent executable source code written in a well-known language, such as, for example, C, C++, C#, Java, or the like. Embodiments described herein may be practiced in distributed computing environments where tasks are performed by remote-processing devices that are linked through one or more communications networks.

With continued reference to FIG. 1A, in some embodiments computing device 10 includes a bus 12 that directly or indirectly couples the following devices: memory 14, one or more processors 16, one or more presentation components 18, input/output ports 20, input/output components 22 and an illustrative power supply 24. Bus 12 represents what may be one or more busses (such as an address bus, data bus, or combination thereof). Although the various blocks of FIG. 1A are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It will be understood by those skilled in the art that such is the nature of the art, and the diagram of FIG. 1A is merely illustrative of an exemplary computing device that can be used in connection with one or more embodiments of the present invention. Distinction is not made between such categories as “workstation,” “server,” “laptop,” “hand-held device,” “smartphone,” etc., as all are contemplated within the scope of FIG. 1A and referenced to as a “computing device.”

The computing device 10 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by the computing device 10.

The memory 14 includes computer-storage media in the form of volatile and/or nonvolatile memory and may or may not be cloud-based. The memory 14 may be removable, nonremovable, or a combination thereof. Exemplary hardware devices include solid-state memory, hard drives, cache, optical-disc drives, etc. The computing device 10 includes one or more processors 16 that read data from various entities such as memory 14 or I/O components 22. The presentation component(s) 18 present data indications to a user or other device. Exemplary presentation components 18 include a display device, speaker, printing component, vibrating component, etc.

The I/O ports 20 allow computing device 10 to be logically coupled to other devices including I/O components 22, some of which may be built in. Illustrative components include a microphone, joystick, game pad, satellite dish, scanner, printer, wireless device, keypad etc.

Turning now to FIG. 1B, a block diagram depicting a networking architecture 200 is shown for use in implementing embodiments described herein. The networking architecture 200 includes a plurality of user computing devices, such as user computing devices 202, a digital media server 204, a triggering event server 206, a greetings server 208, and a processor 240, all of which may communicate with each other via a network 210. The networking architecture 200 is merely an example of one suitable networking environment and is not intended to suggest any limitation as to the scope of use or functionality of the present disclosure. Neither should networking architecture 200 be interpreted as necessarily having any dependency or requirement related to any single component or combination of components illustrated therein. For example, the servers 204, 206 and 208 may be separate servers, may be co-located in a single server, or may be spread across multiple servers.

The user computing devices 202 may be any type of computing device, such as device 10 described above with reference to FIG. 1A. By way of example only and not limitation, the user computing device 202 may be a personal computer, desktop computer, laptop computer, handheld device, cellular phone, digital phone, smartphone, PDA, tablet, wearables, or the like. It should be noted that embodiments are not limited to implementation on such computing devices.

The network 210 may include any computer network or combination thereof. Examples of computer networks configurable to operate as network 210 include, without limitation, a wireless network, landline, cable line, digital subscriber line (DSL), fiber-optic line, local area network (LAN), wide area network (WAN), metropolitan area network (MAN), IP network, or the like. The network 210 is not limited, however, to connections coupling separate computer units. Rather, the network 210 may also include subsystems that transfer data between servers or computing devices. For example, the network 210 may also include a point-to-point connection, the Internet, an Ethernet, an electrical bus, a neural network, or other internal system.

In an embodiment where the network 210 comprises a LAN networking environment, components may be connected to the LAN through a network interface or adapter. In an embodiment where the network 210 comprises a WAN networking environment, components may use a modem, or other means for establishing communications over the WAN, to communicate. In embodiments where the network 210 comprises a MAN networking environment, components may be connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

Furthermore, the network 210 may also include various components necessary to facilitate communication with a mobile phone (e.g., cellular phone, smartphone, Blackberry®). Such components may include, without limitation, switching stations, cell sites, Public Switched Telephone Network interconnections, hybrid fiber coaxial cables, or the like.

The digital media server 204, the triggering event server 206, and the greetings server 208 may be any type and/or combination of application servers, database servers, or file servers configurable to perform the methods described herein. In addition, each of the servers 204, 206 and 208 may be one or more dedicated or shared servers. In some embodiments, the servers 204, 206 and 208 are a single server while in other embodiments the servers 204, 206 and 208 are separate servers. In other embodiments, some or all of one or more of the servers 204, 206, 208 are located on the user computing device 202. One example, without limitation, of a server that is configurable to operate as the server 204, 206 or 208 is a PowerEdge server manufactured by Dell, Inc. The servers 204, 206 and 208 may also be configured to run server software, such as SQL Server 2005, which was developed by the Microsoft® Corporation, Apache HTTP Server Project, developed by the Apache Software Foundation, or some other proprietary server software, such as a proprietary IBM iseries server that will not run Microsoft software but runs software written in RPG that is compiled on an IBM operating system.

Components of the servers 204, 206 and 208 may include, without limitation, a processing unit, internal system memory, and a suitable system bus for coupling various system components, including one or more databases for storing information (e.g., files and metadata associated therewith). Each server may also include, or be given access to, a variety of computer-readable media. By way of example, and not limitation, computer-readable media may include computer-storage media and communication media. In general, communication media enables each server to exchange data via network 210. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that networking architecture 200 is merely exemplary. While the servers 204, 206 and 208 are illustrated as single boxes, one skilled in the art will appreciate that they may be scalable. For example, the servers 204, 206 and 208 may in actuality include multiple boxes in communication. The single unit depictions are meant for clarity, not to limit the scope of embodiments in any form.

The user computing devices, such as user computing devices 202, may include web browsers 212, text message capability 230, email capability 232 and push notification capability 234. In some embodiments, the web browsers are software applications enabling a user to display and interact with information located on a web page, such as web page or a user interface. In an embodiment, the web browser 212 may communicate with the servers 204, 206 and 208 over the network 210. The web browser 212 may locate web pages by sending a transferring protocol and the URL. The web browser 212 may use various URL types and protocols, such as hypertext transfer protocol (HTTP), file transfer protocol (FTP), real-time streaming protocol (RTSP), etc. The web browser 212 may also understand a number of file formats—such as HTML, graphics interchange format (GIF), tagged image file format (TIFF), portable document format (PDF), or joint photographic experts group (JPEG) file format, and the like—the wealth of which can be extended by downloaded plug-ins. Additionally, the web browser 212 may be any browser capable of navigating the Web, such as Internet Explorer®, Netscape Navigator, Mozilla, Firefox, etc.

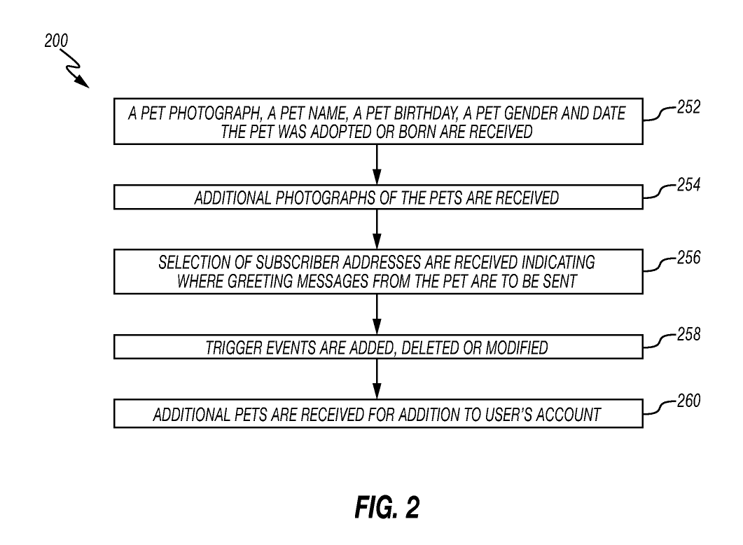

FIG. 2 is a flowchart 200 of an example method for setting up a pet, child or person identifier with associated photographs, videos, other digital content and trigger events, using the architecture described above. In some embodiments, the method begins and the user submits a pet photograph, video or other digital content, a pet name, a pet birthday, a pet gender, and date the pet was adopted or born, as illustrated at block 252. In other embodiments, the user may submit similar information for a child or person with communication limitations.

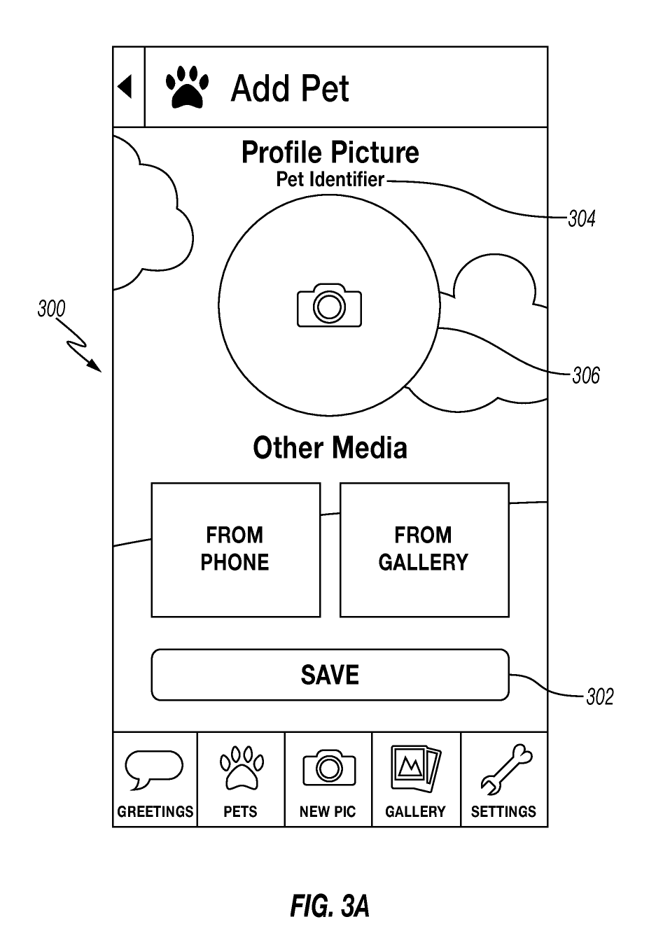

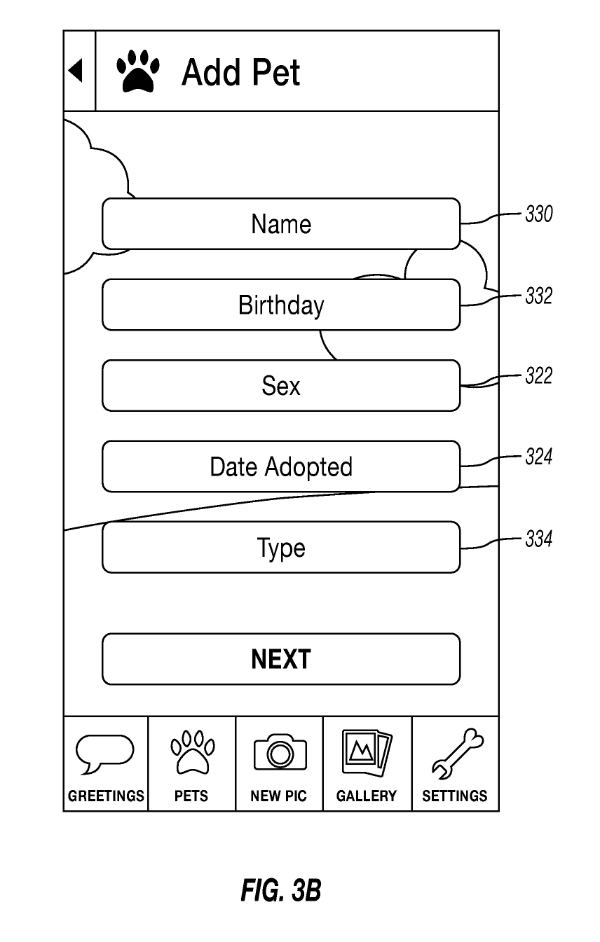

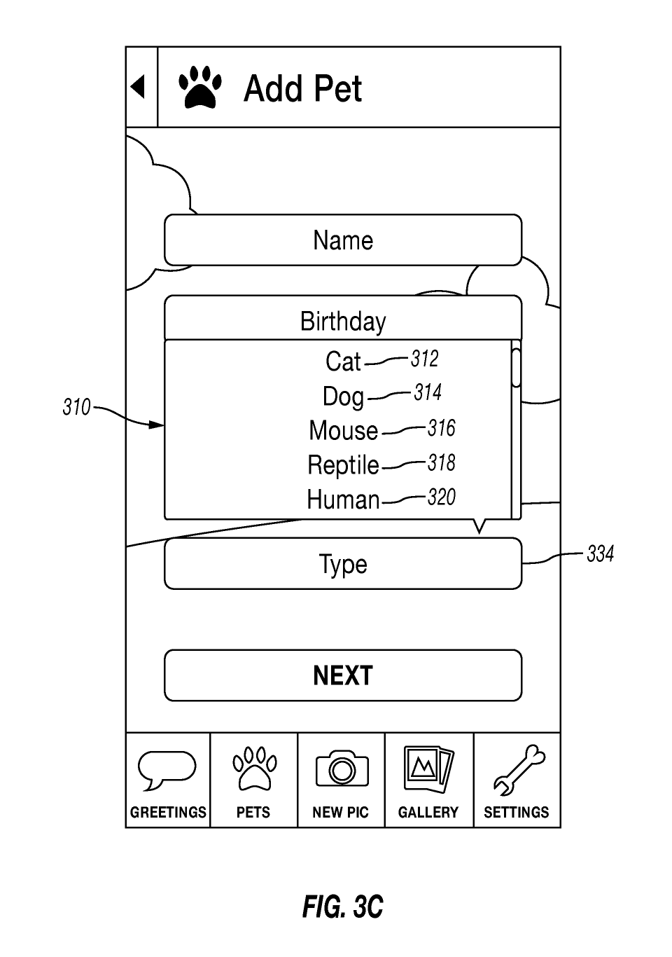

For example, as shown in FIG. 3A, the system may display a user interface 300 that includes options for adding a profile picture 306 from the user's computing device 202. The user may save 302 the picture 306, and the system associates the picture 306 with a pet identifier 304. In some embodiments, the picture 306 is stored in the photo server 204. In other embodiments, the user can add additional pictures, videos, animation, sounds or other digital content associated with the pet identifier 304.

In some embodiments, the user can also input additional information about the pet, child or person as illustrated in FIG. 3B. For example, the user can input a pet name 330, a pet birthday 332, a pet gender 322, the date the pet was adopted or born 324, and a pet type 334. The system associates the additional information with the pet identifier 304, child identifier, or person identifier, respectively. In some embodiments, each item of information includes a drop-down menu containing options. For example, in the embodiment illustrated in FIG. 3C the user may select the type of pet option 334, which will generate a drop-down menu 310 displaying various pet-type options such as, for example, cat 312, dog 314, mouse 316, reptile 318, or human 320.

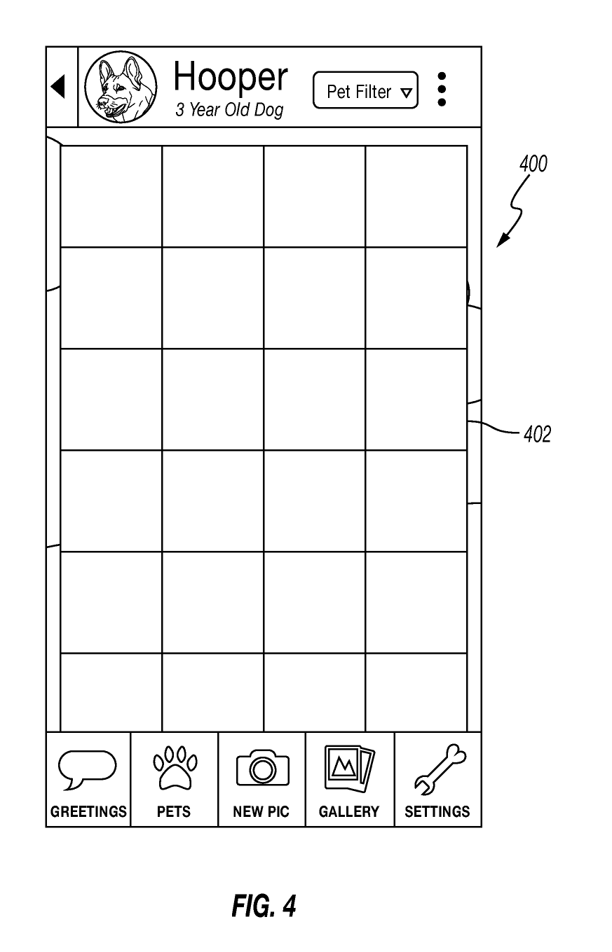

Referring again to FIG. 2, the user can then upload additional photographs or other digital media relating to the pet, child or person with communication limitations, as illustrated at block 254. For example, as shown in FIG. 4, in some embodiments the system displays a user interface 400 allowing a user to add a plurality of photographs 402, videos, animations, sounds or other digital content for each pet, child or person with communication limitations. Each of the photographs 402 and other digital content is associated with the corresponding pet identifier, child identifier or person identifier for the appropriate pet, child or person. In some embodiments, such as the embodiment depicted in FIG. 4, the user can view all of the photographs 402 and other digital content associated with a particular identifier via the user interface 400.

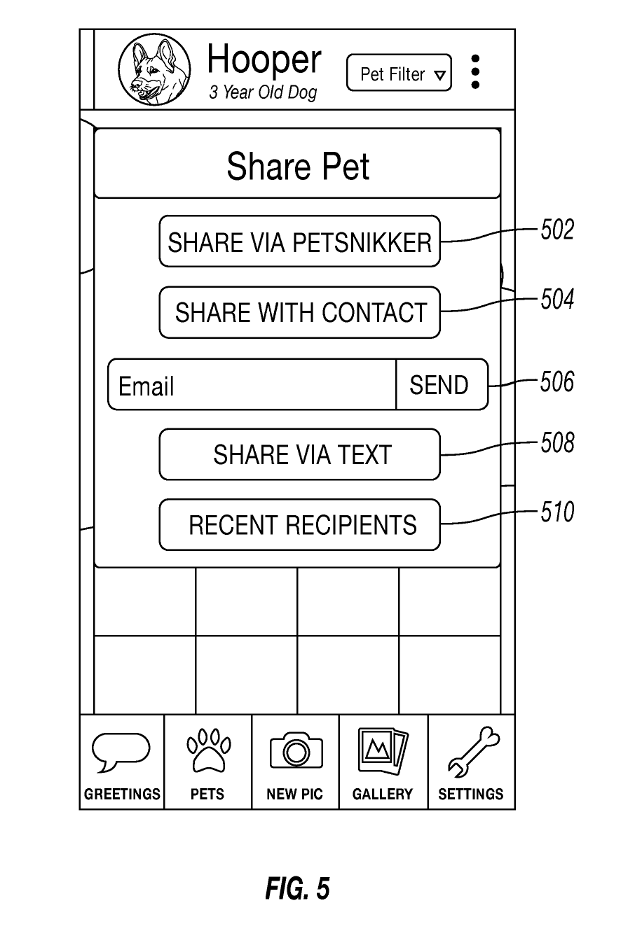

Referring again to FIG. 2, the user then selects how the user would like to invite third parties to receive messages and/or digital content associated with one or more pet, child or person identifiers. In other embodiments, the user can also select how each third party will receive messages and/or digital content from the pet, child or person with communication limitations, as illustrated at block 256. For example, as shown in FIG. 5, in some embodiments the system displays a user interface having various options for sharing greetings from a pet identifier. The user can choose to share greetings from a pet identifier via the system application by selecting the system application option 502. Alternately, the user may choose to share greetings from a pet identifier by selecting the users contact list option 504, email option 506, text message option 508, or recent recipients option 510. In other embodiments, the user can share greetings via social media applications, such as, but not limited to, Facebook, Twitter, MySpace, LinkedIn, Twitter, Pintrest, Instagram, or other social applications. In some embodiments, the user can share invitations to other users who are not users of the system application, for example, via the users contact list 504, via email 506, via text message 508, to one or more recent recipients 510, via Facebook, via Twitter, or via another social application.

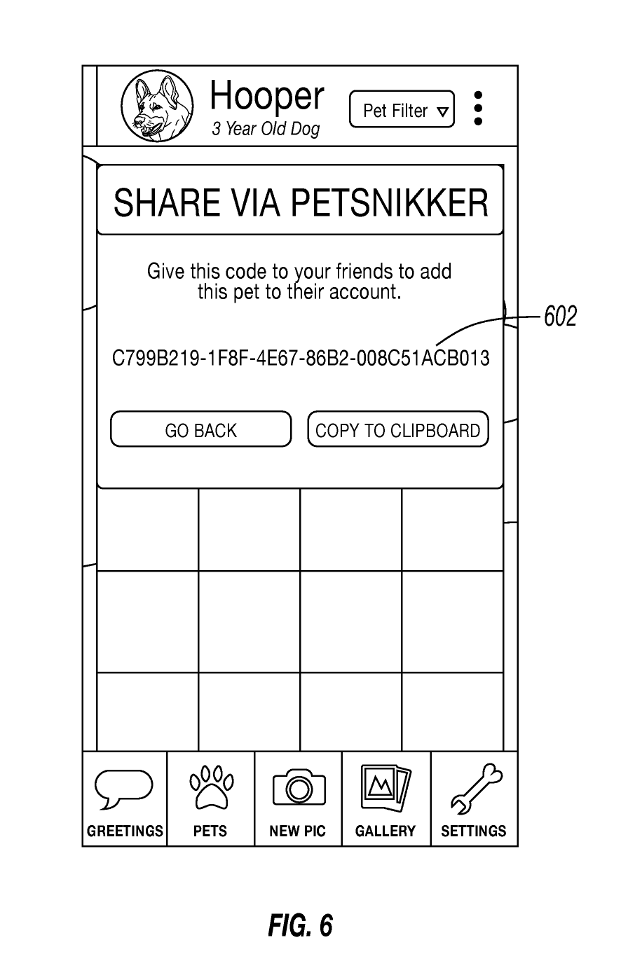

Referring now to FIG. 6, in some embodiments when a user chooses to share greetings through the system application by selecting the corresponding option 502 shown in FIG. 5, the system sends a code 602 to a subscriber and the subscriber can enter the code 602 in the system application to receive messages from the corresponding pet, child, or person identifier. When a user chooses to share an invitation, the system sends the code 602 via the chosen communication method (e.g., via the users contact list, via email, via text message) to the third party, and the third party can enter the code into the system to receive access to messages pertaining to the particular pet identifier associated with the code. In some embodiments, the user cannot receive messages unless the user is a member (subscriber) of the system or receives an invitation to join from a current user.

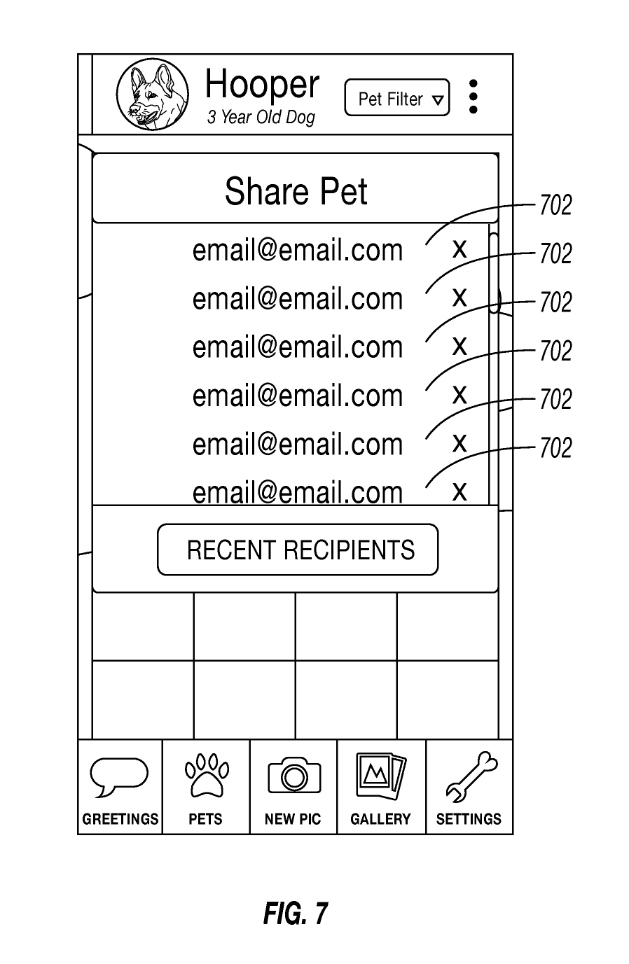

In some embodiments, a user can enter a plurality of subscriber addresses that will receive greeting messages from a particular pet identifier, child identifier or person identifier. Thus, for example, a user may enter several email addresses for a particular pet, child or person identifier, some of which may pertain to the user and others which may pertain to third parties, such as the user's relatives and friends. Thus, when a message is sent relating to the pet, child or person identifier, each of the subscribers associated with that pet, child or person identifier will receive a greeting message via the chosen method of communication, such as, for example, via email, via text, or some other method. For example, as shown in FIG. 7, in some embodiments the user can add a plurality of subscriber email addresses 702 to receive greeting messages from a pet, child or person identifier.

In other embodiments, the user sends, via the system, invitations, which may be weblinks or other digital features, to the plurality of potential subscribers and the potential subscribers must first download a mobile app before the subscribers can receive messages and digital content. In some embodiments, the messages and digital content are received by the user and the third parties as push notifications from the mobile app.

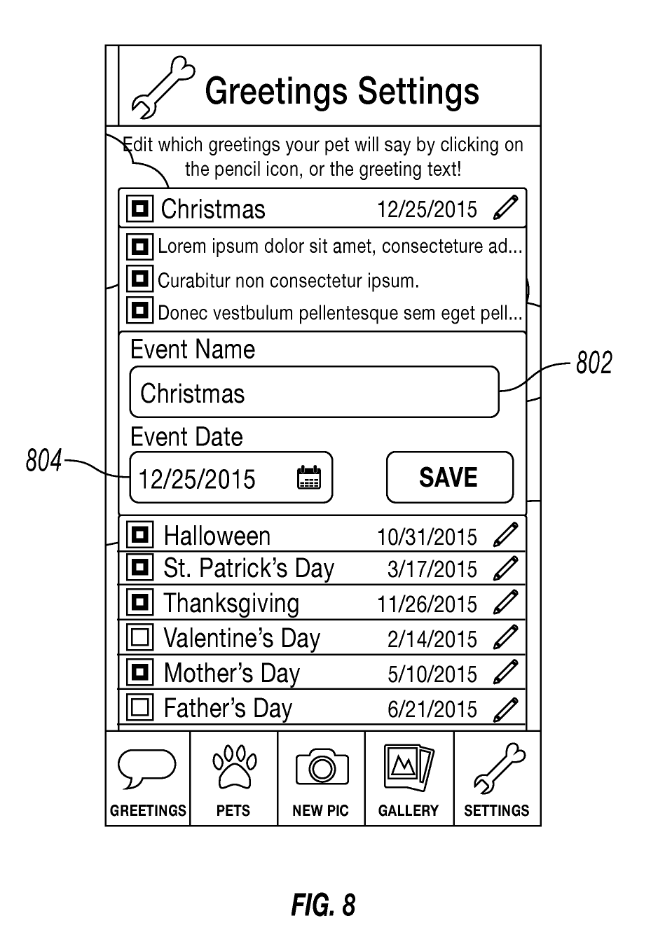

Referring again to FIG. 2, in some embodiments the user and subscribers can then add, delete or modify triggering events on which the user and subscribers associated with a particular pet, child or person identifier will receive a greeting message from the pet, child or person, as illustrated at block 258. For example, as shown in FIG. 8, in some embodiments the system generates a user interface displaying trigger events associated with a pet, child or person identifier. In some embodiments, the trigger events correspond to holidays, birthdays, or other events. In some embodiments, a user can modify the trigger events, such as, for example, by modifying an event name 802 and an associated calendar date 804. In some embodiments, a user can also add or delete triggering events, such as event dates, to increase or decrease the number and frequency of greeting messages and/or digital content received from a particular pet, child or person identifier.

In some embodiments, the triggering event is engaged when a current status corresponds to the triggering event. For example, in some embodiments the triggering event is engaged when a current status, such as a geographic location of a user's computing device 10, is at a particular geographic location or within a specified distance of a particular geographic location. For example, in some embodiments the system sends a message (e.g., via the triggering event server 206) to a user's account when the user's computing device 10 is within a specified distance of a shopping center or another subscriber to the pet, child or person identifier. In another embodiment, the system sends a message to a user's account when the user's computing device 10 leaves a specified radius of a location, such as the user's home. For example, in some embodiments the system sends a message to a user's account when the user's computing device 10 is 200 miles beyond its home. In some embodiments, the system activates and delivers a text message to the owner from the pet, child or person identifier that says, “Bone Voyage,” with digital media pertaining to the pet, such as an image of the pet. In some embodiments, once an owner arrives at a destination, the triggering event server 206 sends a message such as, “Grandma, please bring me a souvenir from Florida.” In other embodiments, once an owner returns from a trip to within the 200 mile criteria, the triggering event server 206 generates another text from the owner's album that states, “Welcome home and by the way, I did not make this mess.”

In some embodiments, a user and subscribers can select when or how often they receive messages pertaining to a particular trigger event. Thus, in some embodiments, a user may specify that it would like to receive a maximum number of messages per day, week, or month.

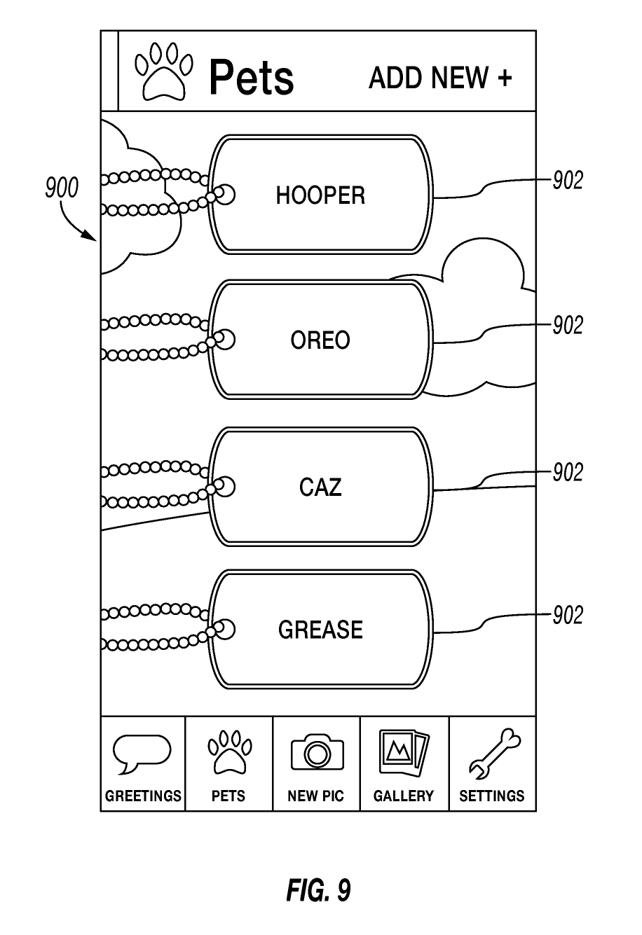

Referring again to FIG. 2, the user can then add additional pets, children, or other people to the user's account, as illustrated at block 260. Referring to FIG. 9, for example, in some embodiments a user can access the user interface 900 generated by the system to add multiple pet, child or person identifiers 902 that each include a unique identifier and name.

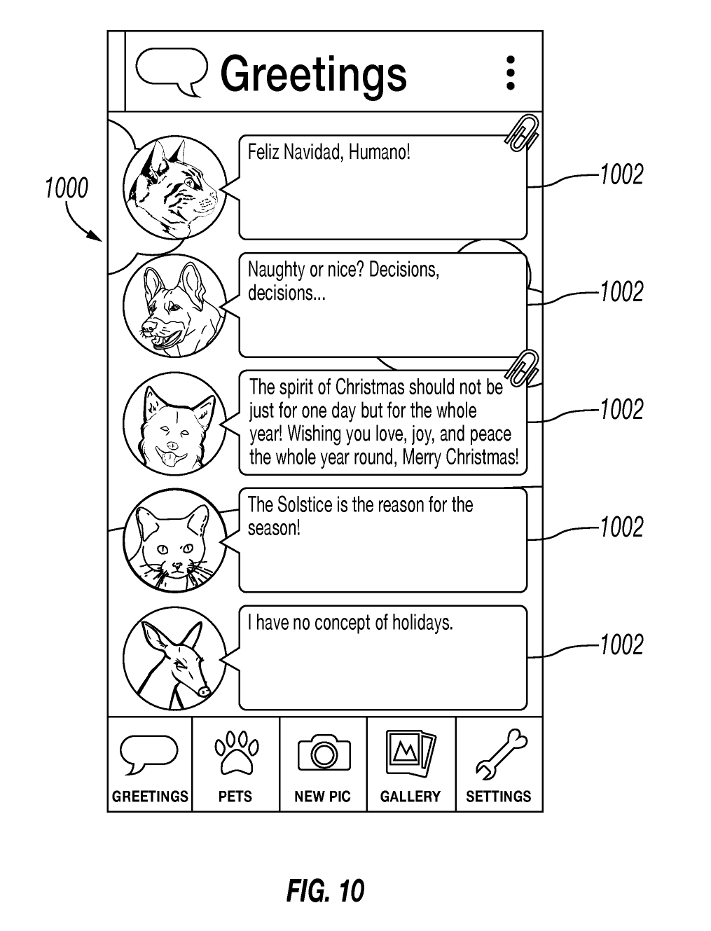

Referring now to FIG. 10, in some embodiments the greetings server 208 generates a user interface 1000 to display all of the past greeting messages 1002 and electronic media from pets, children and other people on a user's account.

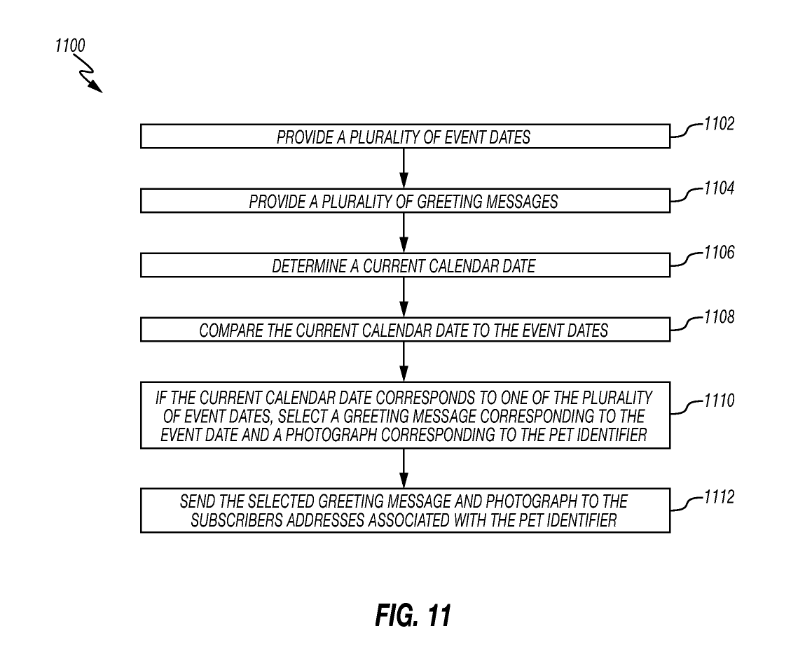

FIG. 11 illustrates a flowchart 1100 of a method of operation by the system for delivering greeting messages to subscribers associated with a pet identifier. The method begins, and the processor 240 retrieves or receives a plurality of trigger events from the triggering event server 206. In some embodiments, the trigger events are calendar dates, as illustrated at block 1102, GPS-initiated triggers, or other triggering events. In some embodiments, the event dates include user-specified dates such as birthdays, holidays, and other special dates in the life of the user. In some embodiments, the triggering event server 206 includes pre-set dates that the user can accept or modify. In other embodiments, the triggering events are GPS locations or distances from a GPS location. In other embodiments, the triggering events can be any event that engages the system to send a message to the user and/or subscribers.

In some embodiments, the greeting server 208 generates a plurality of greeting messages, as illustrated at block 1104. In some embodiments, the greeting messages correspond to one or more of the plurality of triggering events. For example, in some embodiments the greeting messages pertain to general holidays or person dates, such as birthdates. Thus, for example, a greeting message for the Christmas holiday may include the phrase, “Merry Christmas, From Your Best Friend.” In another embodiment, an example greeting message for New Year's Eve may include the phrase, “Hope you Have a Hoppy New Year, From your Best Bunny.” It should be understood other greeting messages may be used.

In some embodiments, the processor 240 sends the message in response to a current status corresponding to a triggering event. The message may include randomly selected messages pertaining to the triggering event and/or the pet, child or person identifier. In other embodiments, the message is randomly selected by the processor 240 from a plurality of messages in the greetings server 208 pertaining to a type of pet, child or person identifier. Thus, for example and not by way of limitation, in some embodiments the message database associated with the greetings server 208 includes a plurality of messages for dogs, another plurality of messages for cats, and an additional plurality of messages for birds, etc. In other embodiments, the message database includes a plurality of messages pertaining to other animals, children or persons. In some embodiments, the messages are predefined messages. In yet other embodiments, at least some of the messages are user-defined messages. Thus, in some embodiments a user can create messages pertaining to a specific pet, child or person identifier, a triggering event, a group of pets, children or persons, a group of triggering events, or a combination of pets, children or person identifiers and triggering events. For example, in some embodiments the message includes a recording of the user's dog barking, an animation of the user's dog, music selected by the user or another form of media selected by the user. In some embodiments, a predetermined message is associated with each triggering event rather than randomly selecting a message.

In some embodiments, the processor 240, which may be one or more systems processors and/or client processors, determines a current status, which may be a current location, calendar date or other characteristic, to determine if there is a match between the current status and a trigger event, as illustrated at block 1106. In some embodiments, the date comparison component 242 of the processor or processors 240 compares the triggering event with a current status, such as by comparing a current location or current calendar date to a trigger location or trigger event dates in the trigger event server 206, as illustrated at block, 1108. In some embodiments, if the current calendar date corresponds to one of the plurality of event dates, the message component 244 randomly selects, from the greetings server 208, one of the plurality of greeting messages corresponding to the event date and selects, from the digital media server 204, one of the plurality of photographs corresponding to the pet identifier, as illustrated at block 1110, and transmits the selected greeting message and photograph to the subscribers' addresses associated with the pet identifier, as illustrated at block 1112.

In other embodiments, if the current location corresponds to one of the plurality of event locations, the message component 244 randomly selects, from the greetings server 208, one of the plurality of greeting messages corresponding to the trigger event and selects, from the digital media server 204, one of the plurality of photographs, videos or other digital content corresponding to the pet, child or person identifier, as illustrated at block 1110, and sends the selected greeting message and photograph, video or other digital content to the subscribers addresses associated with the pet, child or person identifier, as illustrated at block 1112.

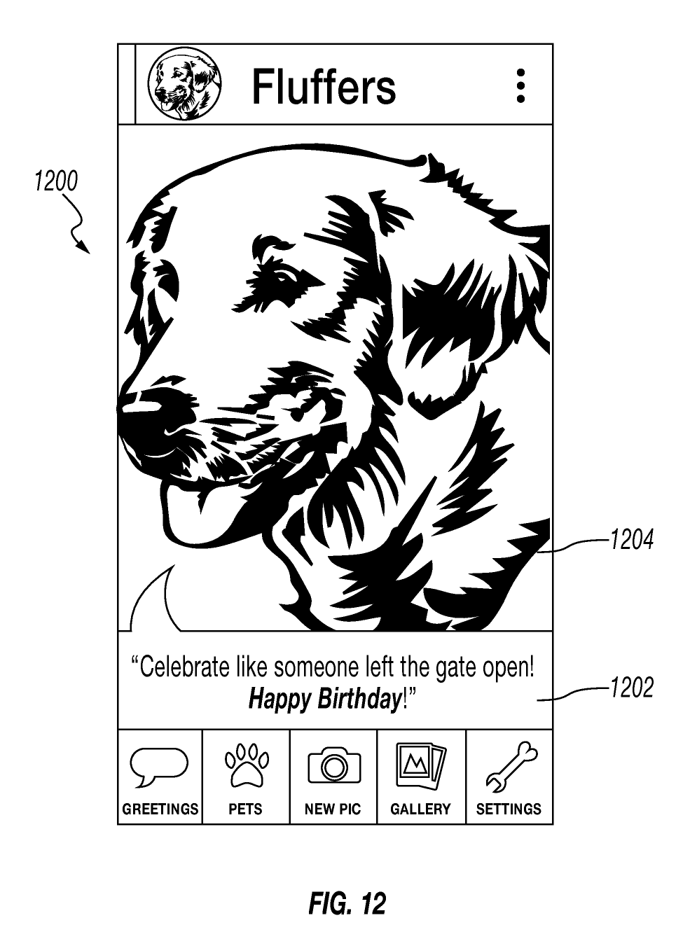

In some embodiments, the message component 244 combines the selected greeting message and the selected photograph, video or other digital content to form a combined message that includes both the greeting message and the photograph in a single image. For example, in some embodiments, the message may be a verbal message and the video may be adapted so that the mouth of the pet, child or person moves as if the pet, child or person is speaking the verbal message. For example, as shown in FIG. 12, a user interface 1200 is generated by the processor 240 to display the greeting message 1202 below and partially overlaying the selected photograph 1204. Thus, the user computing device 202 of a user and other subscribers associated with the pet identifier receive a message and photograph that appear to have come directly from the pet.

In other embodiments, the processor 240, which may be one or more systems processors and/or client processors stored on or accessed by the user's computer device 202, determines a current status, such as a current location, calendar date or other characteristic, and compares the current status to a trigger event stored in the triggering event server 206 to determine if there is a match or correspondence with a trigger event, as illustrated at block 1106. For example, in some embodiments the processor of the user's computing device compares the location of the user's computing device with a plurality of trigger locations stored on the user's computing device 202. In some embodiments, if the current location corresponds to one of the trigger locations, the message component 244, which may be located on the user's computing device 202 or elsewhere, randomly selects one of the plurality of greeting messages corresponding to the trigger location and one of the plurality of photographs, videos, automation, or other electronic media corresponding to the pet, child or person identifier, and sends or displays the selected greeting message and electronic media to the subscribers' addresses associated with the pet identifier. In some embodiments, the greeting message and electronic media are sent only to the user's electronic device 202 while in other embodiments, the greeting message and electronic media are sent to the other third-party subscriber electronic devices and/or addresses.

In some embodiments, in addition to the greeting message and the electronic media, the message also includes advertising media. In some embodiments, the advertising media corresponds to the trigger event. For example, in some embodiments a message is sent when the user is in close proximity to a pet store. In some embodiments, the advertising media corresponds to the pet store.

In some embodiments, a combined message from a plurality of identifiers is sent in response to a triggering event. Thus, for example, in some embodiments a user that has more than one pet will receive a single message with digital media associated with one or more of the pets in response to a triggering event. Thus, the user may receive a single message such as “Happy Birthday, Dad!” from all of the user's pets rather than receiving several different messages from each of the user's pet. In some embodiments, the electronic media associated with the message is a combination of, or includes, digital media from each of the user's pets. Thus, in some embodiments the digital media includes a picture of each of the user's pets.

Appendices A, B and C—incorporated herein by reference to U.S. Provisional Application No. 62/257,638—include additional details and embodiments regarding the processes and systems outlined above and form part of this disclosure.

While the processes and systems have been described in connection with pets, such as dogs, in other embodiments the processes and systems are used in connection with other non-traditional pets, for example, pigs and cows. In yet other embodiments, the processes and systems are used in connection with humans who are unable to communicate or are limited in their ability to communicate, such as babies, small children or other people with communication limitations. In these embodiments, the photographs depict the relevant non-traditional pet or human, and the messages are configured to match the non-traditional pet or human.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of.” A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, various aspects have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A method, implemented in computer-executable program(s) or computer-executable instruction(s) in computer system(s) or device(s), comprising steps of:
receiving, at a processor, a plurality of event dates from a first server;
receiving, at the processor, at least one photograph associated with an identifier, the at least one photograph received from a second server;
receiving, at the processor, at least one subscriber address associated with the identifier;
receiving, at the processor, a plurality of greeting messages from a third server, wherein each of the plurality of greeting messages corresponds to at least one of the plurality of event dates;
determining, via the processor, a current calendar date;
comparing, via the processor, the current calendar date to the plurality of event dates;
if the current calendar date corresponds to one of the plurality of event dates, selecting, via the processor, one of the plurality of greeting messages corresponding to the one of the plurality of event dates and selecting, via the processor, one of the at least one photograph associated with the identifier; and
transmitting, via the processor, the selected greeting message and the selected photograph to the at least one subscriber address associated with the identifier.

2. The method of claim 1, further comprising combining, via the processor, the selected greeting message and the selected photograph into a combined image.

3. The method of claim 1, wherein combining the selected greeting message and the selected photograph into a combined image further comprises positioning the selected greeting message in an overlaid position on at least part of the selected photograph.

4. The method of claim 1, wherein at least some of the event dates correspond to holidays.

5. The method of claim 1, wherein at least some of the event dates are user-selected dates.

6. The method of claim 1, wherein the content of each of the plurality of greeting messages relates to a corresponding event date of the plurality of event dates.

7. The method of claim 1, wherein the at least on subscriber address is an email address.

8. A method of delivering a message to a computing device on behalf of a pet, the method comprising:
storing, at a first server, a plurality of pet images corresponding to a first identifier;
receiving a plurality of subscriber addresses corresponding to the first identifier;
storing, at a second server, a plurality of greeting messages, wherein each of the plurality of greeting messages corresponds to a triggering event;
comparing, via a processor, a current status to the triggering event; and
if the current status corresponds to the triggering event, sending, via the processor, at least one of the plurality of pet images and at least one of the plurality of greeting messages corresponding to the triggering event to the subscribers addresses corresponding to the first pet identifier.

9. The method of claim 8, further comprising storing, at the first server, a second plurality of images corresponding to a second pet identifier and receiving a second plurality of subscribers addresses corresponding to the second pet identifier.

10. The method of claim 9, further comprising, if the current status corresponds to one of the plurality of triggering events, sending, via the processor, at least one of the second plurality of pet images and at least one of the plurality of greeting messages corresponding to the triggering event to the second plurality of subscriber addresses.

11. The method of claim 10, wherein the subscriber addresses are email addresses.

12. The method of claim 10, wherein the subscriber addresses are phone numbers.

13. The method of claim 12, wherein sending at least one of the plurality of pet images and at least one of the plurality of greeting messages corresponding to the triggering event to the subscribers addresses corresponding to the first pet identifier further comprises combining the at least one of the plurality of pet images and at least one of the plurality of greeting messages into a combined image.

14. The method of claim 13, further comprising, if the current status corresponds to one of the plurality of triggering events, randomly selecting, via the processor, one of the plurality of greeting messages corresponding to the one of the plurality of triggering events.

15. The method of claim 8, wherein the triggering event is a user-selected date.

16. A system for delivering a message to an electronic device on behalf of a pet, the system comprising:
a first server configured to store a plurality of pet images each corresponding to one of a plurality of pet identifiers;
a second server configured to store a plurality of pet greetings each corresponding to one of a plurality of triggering events;
a third server configured to store a plurality of greeting messages each corresponding to one or more of the plurality of triggering events; and
a processor configured to compare a current status to the plurality of event triggers and, if the current status matches one of the plurality of event triggers, to transmit over a network, to a plurality of subscriber addresses associated with a first pet identifier, at least one of the plurality of pet images corresponding to the first pet identifier of the plurality of pet identifiers and one of the plurality of pet greetings corresponding to one of the plurality of triggering events corresponding to the current status.

17. The system of claim 16, wherein the processor is configured to send an electronic message containing the at least one of the plurality of pet images corresponding to the first pet identifier and the one of the plurality of pet greetings corresponding to one of the plurality of triggering events that corresponds to the current status.

18. The system of claim 16, wherein the processor is configured to send an email message containing the at least one of the plurality of pet images corresponding to the first pet identifier of the plurality of pet identifiers and the one of the plurality of pet greetings corresponding to one of the plurality of triggering events that corresponds to the current status.

19. The system of claim 16, wherein the triggering events are event dates.

20. The system of claim 16, wherein the network is a cellular network.
